(19) United States
(12) Patent Application Publication
(10) Pub. No.: US 2015/0243146 A1
(43) Pub. Date: Aug. 27, 2015

(54) ANTI-THEFT TAG

(71) Applicant: USS Technologies, LLC, Rancho Cucamonga, CA (US)

(72) Inventors: Adel O. Sayegh, Rancho Cucamonga, CA (US); Anthony Oliver, Rancho Cucamonga, CA (US); Marc Trincale, Rancho Cucamonga, CA (US); Andrew Gabriel, Rancho Cucamonga, CA (US); Nathanial Reed, Rancho Cucamonga, CA (US)

(21) Appl. No.: 14/589,957

(22) Filed: Jan. 5, 2015

Related U.S. Application Data
(60) Provisional application No. 61/923,555, filed on Jan. 3, 2014.

(51) Int. Cl. G08B 13/24

(52) U.S. Cl. CPC G08B 13/2434

(57) ABSTRACT

The present invention discloses an anti-theft tag that has a locator module for tracking location of the anti-theft tag, with the locator module providing location information with respect to the location of the anti-theft tag.

### CROSS-REFERENCE TO RELATED APPLICATIONS

This Application claims the benefit of priority of co-pending U.S. Utility Provisional Patent Application No. 61/923,555, filed Jan. 3, 2014, the entire disclosure of which is expressly incorporated by reference herein.

It should be noted that where a definition or use of a term in the incorporated patent application is inconsistent or contrary to the definition of that term provided herein, the definition of that term provided herein applies and the definition of that term in the incorporated patent application does not apply.

### BACKGROUND OF THE INVENTION

1. Field of the Invention

This invention relates to electronic article surveillance (EAS) systems and, more particularly to EAS tags that provide systems for potential recovery of stolen articles.

2. Description of Related Art

Most conventional EAS systems include EAS pedestal systems that are positioned at the ingress/egress locations of retail stores, which trigger an alarm when an EAS tag associated with an article is near the EAS pedestal systems (assuming the EAS tag is not neutralized). Regrettably, known EAS systems (e.g., pedestals, tags, alarms, etc.) do not provide any mechanism for potential recovery of stolen articles that are removed from the store.

Accordingly, in light of the current state of the art and the drawbacks to current EAS systems mentioned above, a need exists for EAS tags that would provide for protection of articles inside the merchant store but also would potentially enable the recovery of stolen article.

### BRIEF SUMMARY OF THE INVENTION

A non-limiting, exemplary aspect of an embodiment of the present invention provides an anti-theft tag, comprising:

a locator module for tracking location of the anti-theft tag;

the locator module providing location information with respect to the location of the anti-theft tag.

Another non-limiting, exemplary aspect of an embodiment of the present invention provides anti-theft tag, comprising:

a locking cable that is coupled with a housing of an anti-theft tag;

the housing of the anti-theft tag includes:

a first member coupled with a second member, forming a hollow internal chamber within which is mounted a locator module for tracking location of the anti-theft tag, and a first side that includes a first aperture for accommodating an actuator switch;

the second member includes a protuberance that houses a clutch;

the first member and the second member include perforated areas that form the grill-openings of the housing for output of audio indicator.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1E are non-limiting, exemplary illustration of the various views of an anti-theft tag in accordance with one or more embodiments of the present invention;

FIG. 2 is an exemplary illustration of the anti-theft tag illustrated in FIGS. 1A to 1E, but with the coupler in an unlocked and open position in accordance with one or more embodiments of the present invention;

FIG. 3A is a non-limiting, exemplary illustration of a first and second internal chambers of respective first and second members of the anti-theft tag illustrated in FIGS. 1A to 2, with the coupler in an unlocked open position in accordance with one or more embodiments of the present invention;

FIG. 3B is a non-limiting, exemplary illustration of a first and second internal chambers of respective first and second members of the anti-theft tag illustrated in FIGS. 1A to 3A, with the coupler in a locked and closed position in accordance with one or more embodiments of the present invention;

FIG. 3C is a non-limiting, exemplary illustration of a clutch of the anti-theft tag illustrated in FIGS. 1A to 3B in accordance with one or more embodiments of the present invention;

FIG. 3D is a non-limiting, exemplary close-up, enlarged view of an area of a second internal chamber that is shown in dashed line in FIG. 3B in accordance with one or more embodiments of the present invention;

FIG. 4A to 4C-2 are non-limiting, exemplary detailed illustration of a locator module of the anti-theft tag illustrated in FIGS. 1A to 3D in accordance with one or more embodiments of the present invention; and

FIG. 4D is a non-limiting, exemplary illustration of a flowchart for process of power management and functionality of the locator module in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers. Further, each block within a flowchart (if a flowchart is used) may represent both method function(s), operation(s), or act(s) and one or more elements for performing the method function(s), operation(s), or act(s). In addition, depending upon the implementation, the corresponding one or more elements may be configured in hardware, software, firmware, or combinations thereof.

One or more embodiments of the present invention provide an EAS tag that has a transponder that triggers an alarm, and includes a locator module for tracking the location of the EAS tag, with the locator module providing location information with respect to the location of the EAS tag. In general, locator modules are well known a non-limiting example of which may includes a locator module provided by TELIT®. Accordingly, when an article associated with the EAS tag of the present invention is still stolen (despite the trigger of an alarm), the locator module of the EAS tag may provide tracking capability and location information of the EAS tag for potential recovery of stolen article.

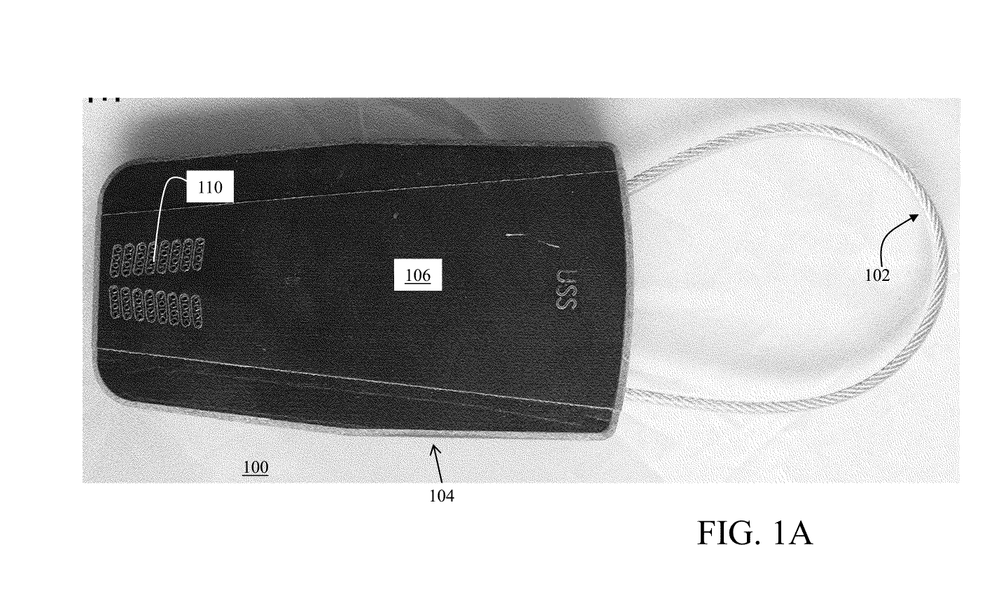

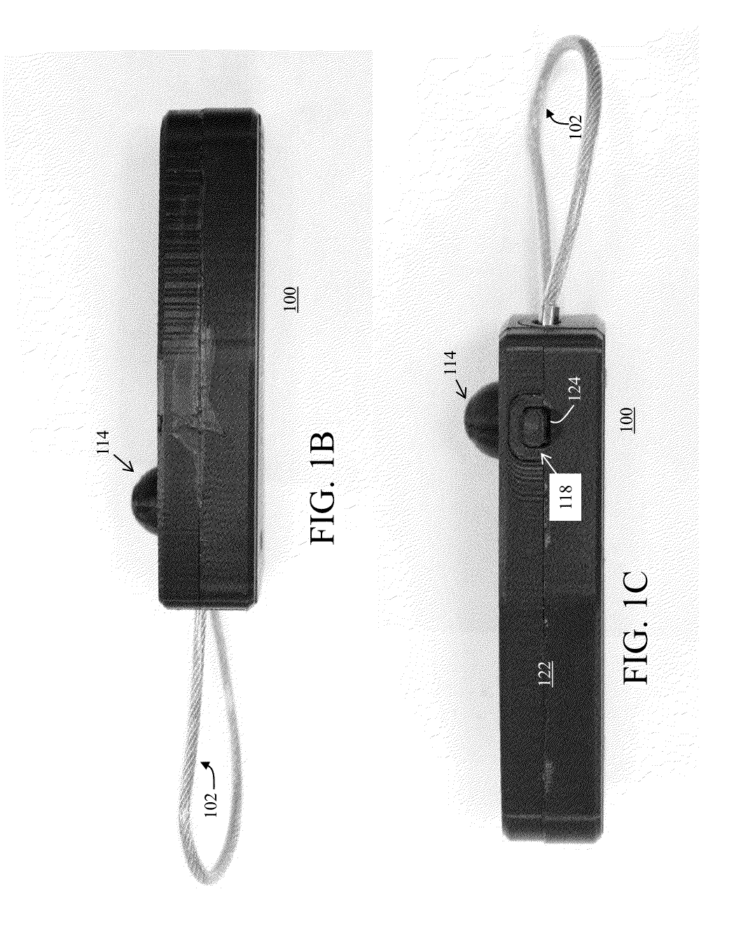

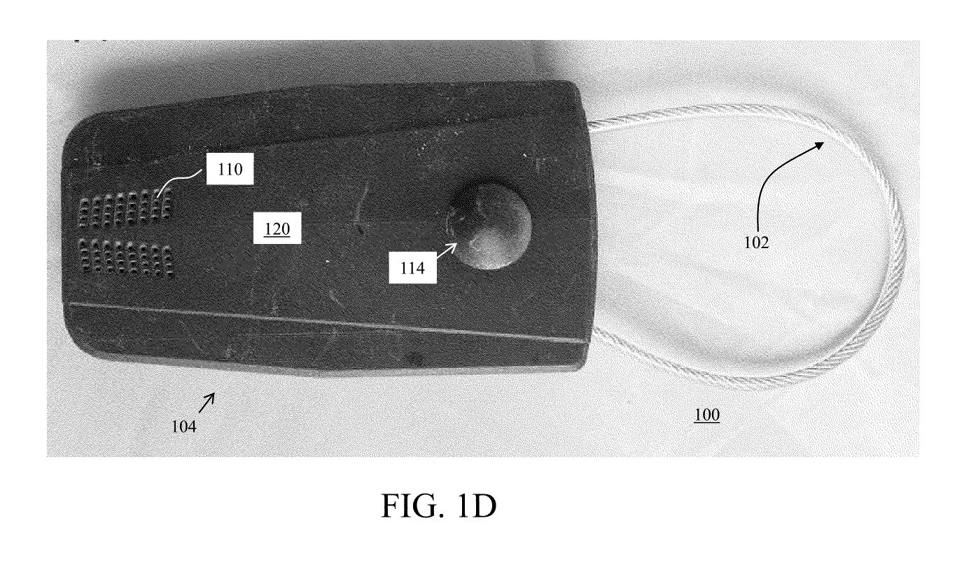

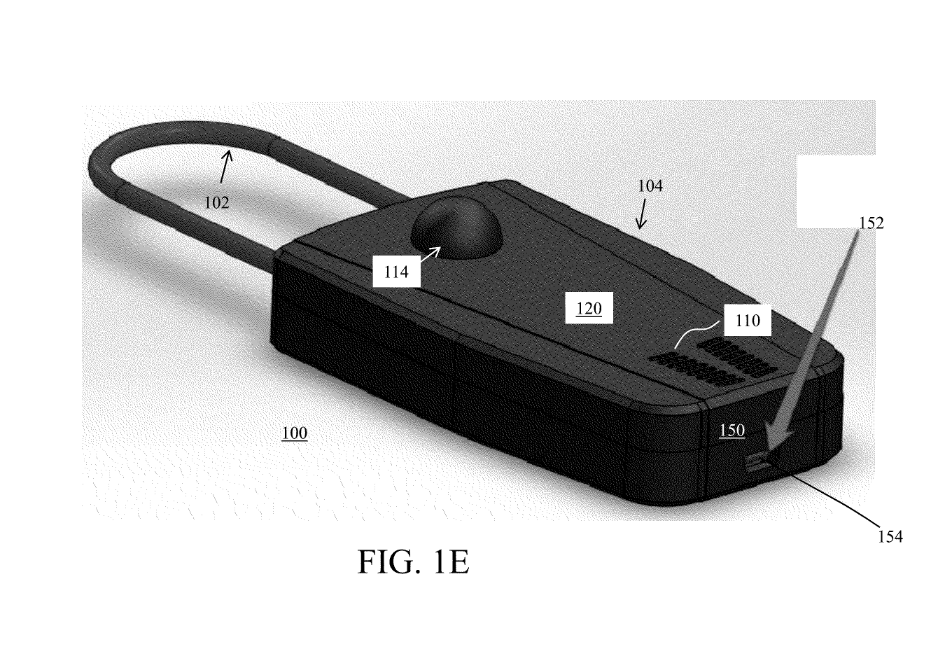

Referring to FIGS. 1A to 1E, the present invention provides an EAS tag 100 having a locking cable 102 that is coupled with a housing 104 of EAS tag 100, with locking cable 102 detachably coupling EAS tag 100 with an article (not shown). Housing 104 of EAS tag 100 includes a first member 106 (FIG. 1A) coupled with a second member 120 (FIG. 1D), forming a hollow internal chamber within which is mounted a locator module and an EAS module. The first and the second member 106 and 102 may be coupled by a variety of mechanisms a non-limiting example of which may include sonic welding.

Housing 104 further includes a first side 122 (FIG. 1C) that includes a first aperture 124 for accommodating an actuator switch 118, and a first end side 150 that includes a second aperture 152 for accommodate a charger port 154 (FIG. 1E) for charging the locator module. First member 106 and the second member 120 include perforated areas that form grill-openings 110 of housing 104 for output of an audio indicator sound (if any) with second member 120 further having a protuberance 114 that houses a clutch 310.

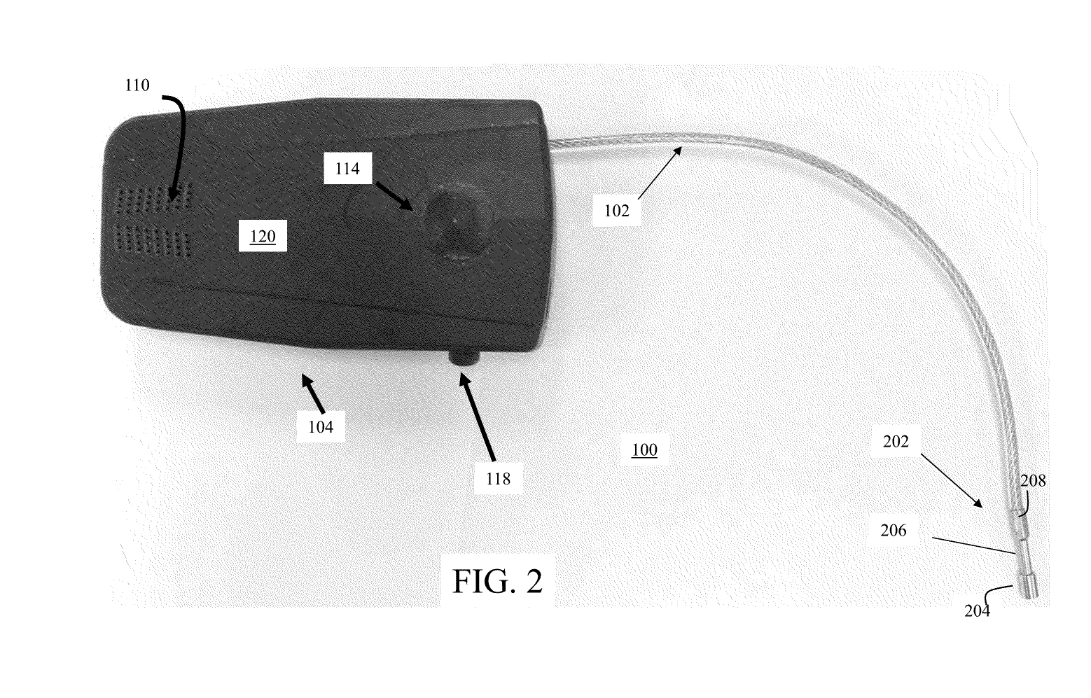

FIG. 2 is a non-limiting, exemplary illustration of EAS tag 100 of FIGS. 1A to 1E, with locking cable 102 in an unlocked, open position. As illustrated, when unlocked, actuator switch 118 is extended (or protruded) out from housing 104, enabling the removal of a locking plug 202 of locking cable 102 from housing 104. The shape, size, and any physical feature of locking plug 202 may be varied. However, in this exemplary instance, locking plug 202 is comprised of a substantially cylindrically tip 204, a neck section 206, and base 208.

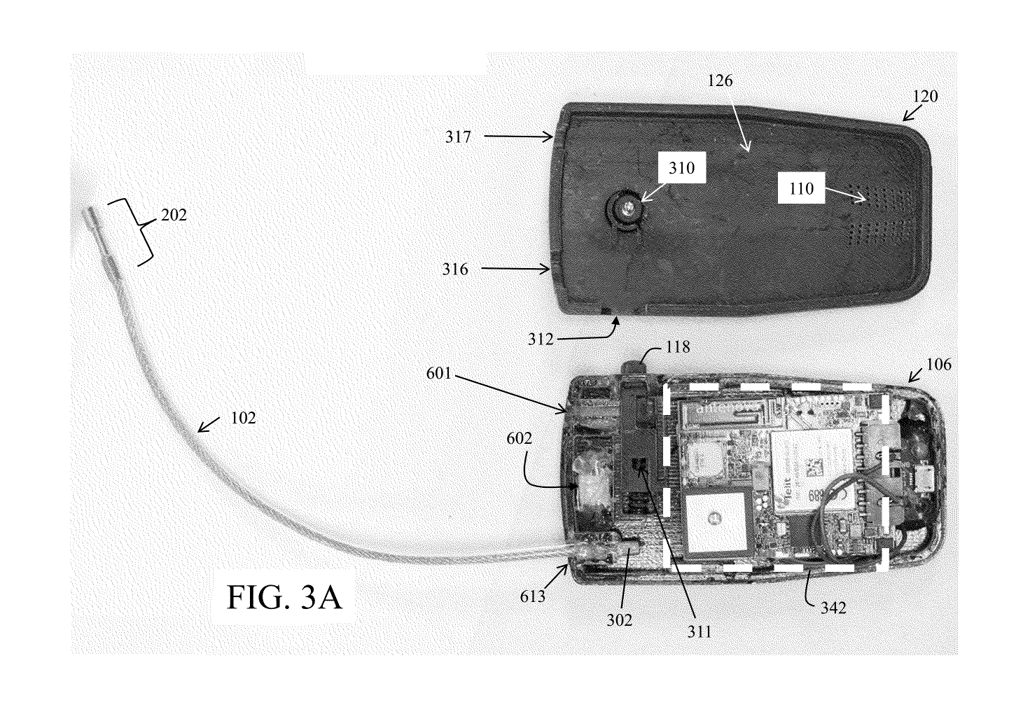

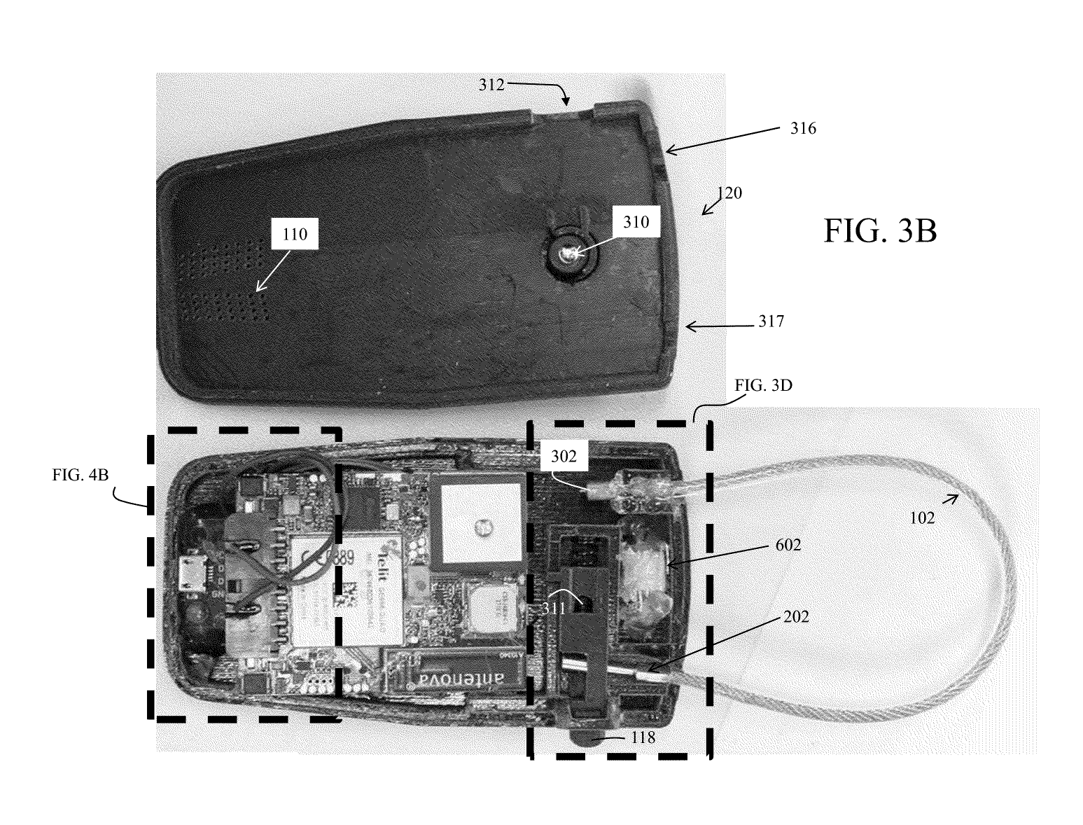

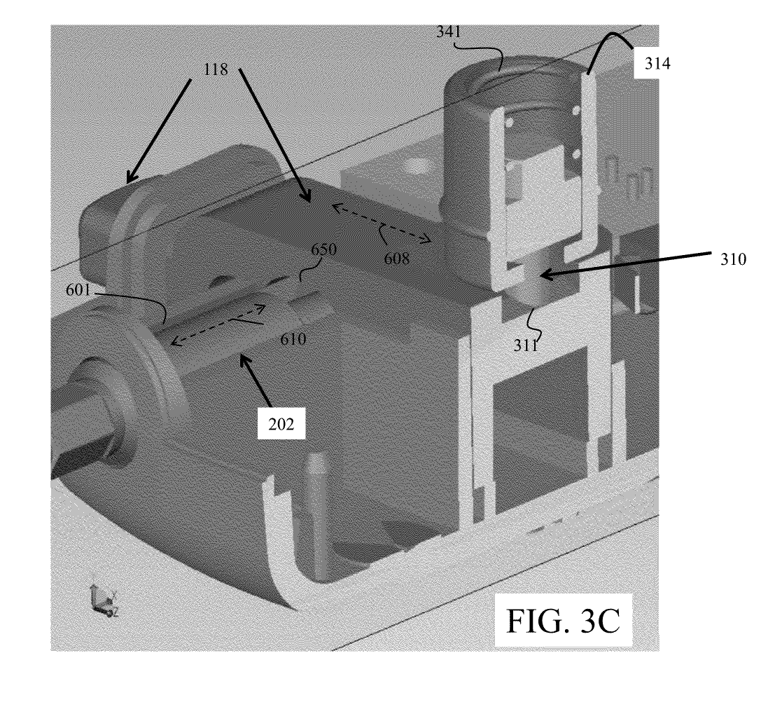

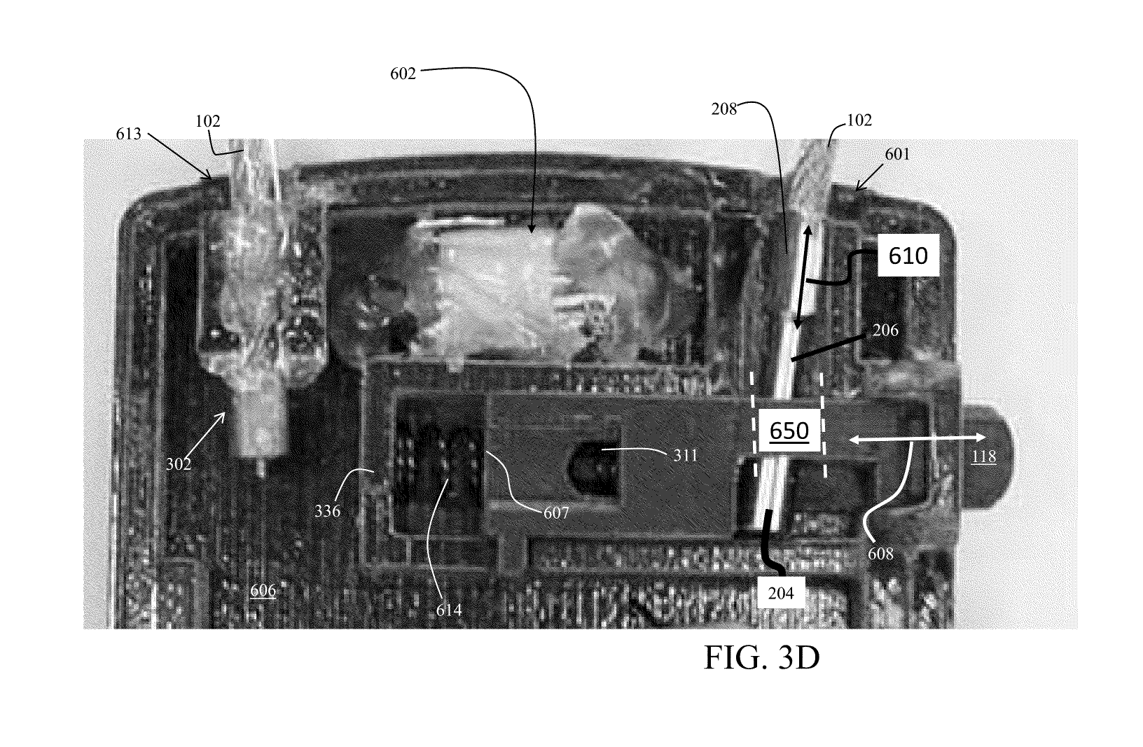

FIGS. 3A to 3D are non-limiting, exemplary illustrations of EAS tag 100 with housing 104 physically separated into first member 106 and second member 120, including illustrating an open locking cable 102. As illustrated, the interior side 126 of second member 120 houses clutch 310, which is biased to an interlock position (projected, raised position) by a biasing mechanism such as a spring 341 (best illustrated in FIG. 3C). Clutch 310 inserts within and interlocks with a clutch aperture 311 to interlock and maintain actuator switch 118 in locked position. As further illustrated in FIGS. 3A to 3D, the interior side 126 of the second member 120 includes a switch actuator opening 312 that accommodates switch actuator 118, and a first cable opening 316 that accommodates locking plug 202 of cable 102, and a second cable opening 317 that accommodates second distal end 302 of the cable 102, which is securely maintained within housing 104.

As further illustrated, EAS tag 100 includes a triggering unit 602 in a form of a transponder. EAS transponders 602 may comprise of elements that respond to specific types of electronic surveillance signals of different types of EAS systems, non-limiting examples of which may include Magnetic, Acousto-Magnetic (AM), Radio Frequency (RF), Microwave, etc. For example, the elements may comprise a ferrite coil antenna that includes an inductor L and capacitor C (e.g., an LC tank) for radio frequency (RF) systems, amorphous metals for Magnetic systems, magnetostrictive and or ferromagnetic amorphous metals for use with acousto-magnetic (AM) systems, or non-linear elements such as a diode for Microwave systems. It should be noted that several transponders of different types may be used within the same EAS tag 100, with each tuned to a different resonant frequency and or systems for activation of different types of EAS systems.

As illustrated in FIGS. 3A, the general area illustrated by the dashed line indicated generally by the reference number 342 includes locator module 340 (detailed below). As best illustrated in FIGS. 3C and 3D, to interlock cable 102 with EAS tag 100, while switch actuator 118 is in the open position, locking plug 202 is inserted along the reciprocating path 610 within a locking channel 601 of the internal chamber of first member 106 of housing 104 of EAS tag 100. Locking plug 202 is further inserted within a transversely oriented hollow portion 650 (illustrated as being underneath dashed lines) of actuator switch 118. Actuator switch 118 is locked with neck 206 of locking plug 202 when locking plug 202 is fully inserted, and actuator switch 118 is fully moved along the reciprocating path 608 to its closed position, pushed against a biasing mechanism 614. Locking plug 202 is fully inserted and its neck 206 interlocked with the transversely oriented hollow portion 650 of actuator switch 118.

As further illustrated in FIG. 3D, actuator switch 118 is further comprised of a generally vertical, transversally oriented clutch aperture 311 that accommodates clutch 310 housed in protuberance 114 of second member 120. Clutch 310 is biased into the clutch aperture 311, which locks actuator switch 118 in closed position against the push of biasing mechanism 614. Actuator switch 118 is moved along reciprocating path 608 to its closed position, pushed against biasing mechanism 614. Clutch 310, which is biased by its own biasing mechanism 341 to a raised or protruded position, contacts a beveled distal edge 607 of actuator switch 118, and is eventually released into clutch aperture 311 to lock actuator switch 118 in its active (or closed) position against the biasing mechanism 614. This action also interlocks neck 206 of locking plug 202 of cable 102 with transversely oriented hollow portion 650 of the actuator switch 118. Accordingly, the mechanical biasing and interlocking interplay between the various components generates a holding strength that is increased under tensile forces that attempt to separate them from their interlocking positions.

A magnetic detacher may be used to release locking plug 202 from the internal chamber and to open actuator switch 118, and unlock cable 102 to open position shown in FIG. 2. The magnetic detacher pulls in metal clutch 310 from its normally protruded position against the bias of resilient member 341, and out and away from clutch aperture 311. This releases actuator switch 118, with biasing mechanism 614 pushing actuator switch 118 to its open position. That is, the movement of actuator switch 118 along path 608 will allow the removal of lock plug 202 from housing 104. Second distal end 302 of cable 102 is inserted through second cable opening 317, with the connector 302 housed within the internal chamber 613.

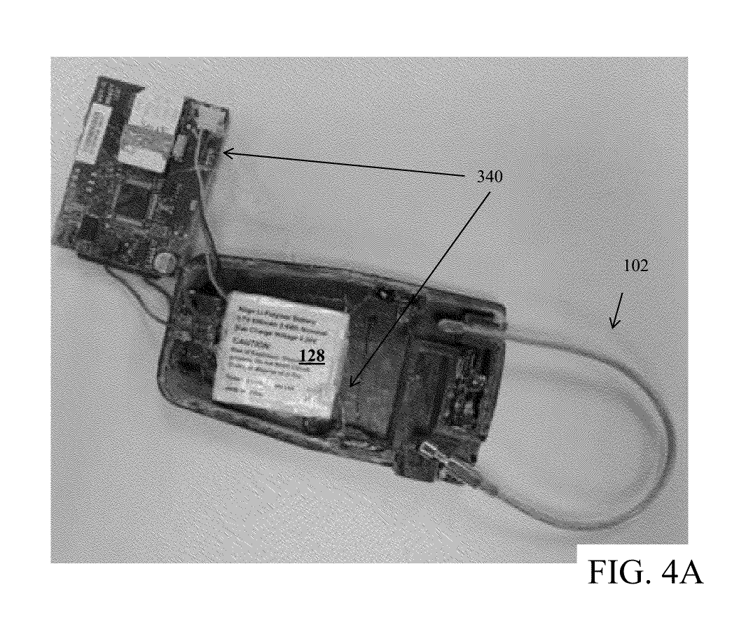

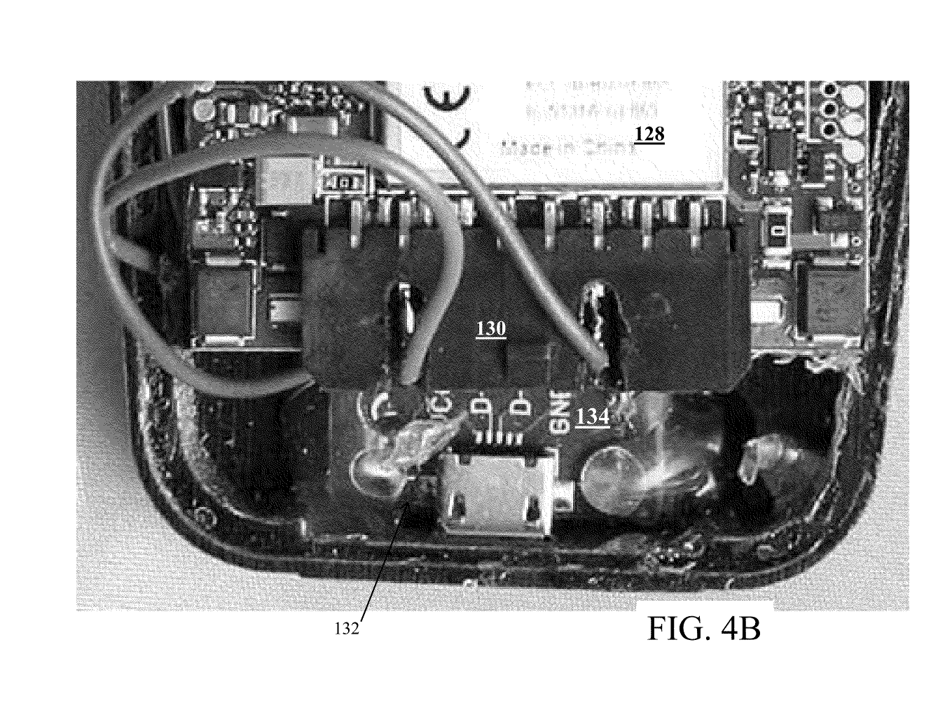

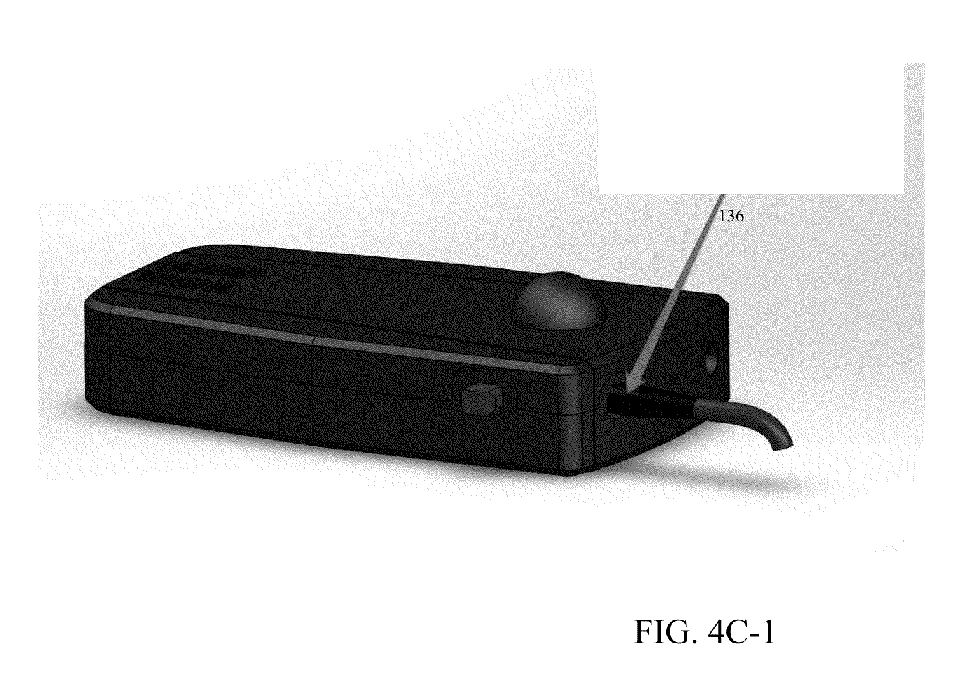

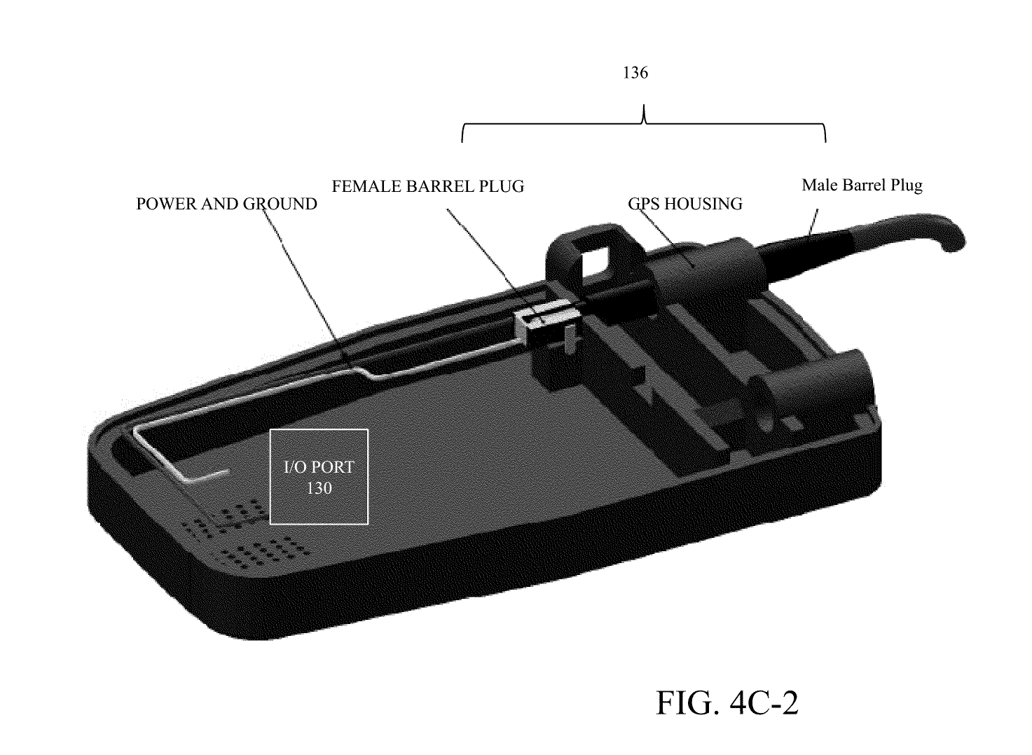

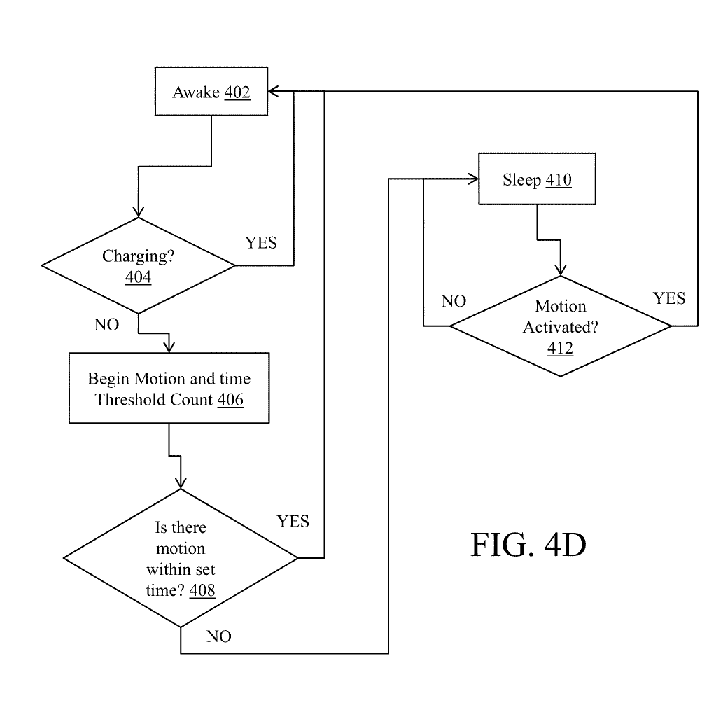

FIG. 4A to 4D are non-limiting, exemplary detailed illustration of a locator module of EAS tag 100. As indicated above, EAS tag 100 of the present invention includes a locator module 340 for tracking location of EAS tag 100 itself. Locator module 340 provides location information with respect to the location of the EAS tag 100. Locator module 340 may comprise of any number of locator systems (or a combinations thereof) such as Global Positioning System (GPS) devices, cellular triangulation devices, etc. which as illustrated, are embedded within the EAS tag 100.

Locator module 340 includes a rechargeable power source 128 for powering continuous communication of location information and data regarding the associated EAS tag 100 with a central point in a well-known manner. Further included with locator module 340 is an input and output (IO) port 130 for both power and data. In general, the rechargeable power source (e.g., a battery) 128 is charged via a charging port 132 coupled with the IO port 130. In one embodiment, the charging port 132 is a Universal Serial Bus (USB) charging port that includes a micro-USB break-out board 134 with power and ground coupled with locator module IO port 130 to recharge power source 128. It should be noted that micro-USB break out board 134 is used because power and ground pins of IO port 130 of locator module 340 are too small and hence, break-out board 314 is used to facilitate USB connections for charging.

As best illustrated in FIG. 4C-1 and 4C-2, instead of a USB charging port 134, the present invention may also be implemented using a well-known, conventional barrel connector 136 using coaxial power connectors to charge rechargeable battery 128. That is, the output of the receptacle of the barrel connector 136 will be coupled with IO port 130 of locator module 340 (similar to the USB charging port connection) in a well-known manner for charging. In this non-limiting, exemplary instance, the charging port 136 is concealed inside the device. As illustrated in FIG. 4C-2, male half of the barrel connector, which plugs into the wall passes through the tags' locking mechanism into the female barrel connector for charging. The female barrel plug is attached to the GPS board in the same manner as the micro USB charger. Once the device is done charging the male barrel plug is removed and the tag can be utilized by placing the lanyard into the hole and locking the tag. Due to the size difference of the barrel connector and the lanyard—the male barrel plug being much smaller—the lanyard does not pass through the locking mechanism still allowing it to lock properly.

FIG. 4D is a non-limiting, exemplary flowchart, which illustrates the power management and functionality of the locator module of EAS tag 100. Assume that at operational 402, locator module 340 is active. This means that locator module 340 continuously transmits location information (e.g., location or other data) regarding the current position of EAS tag 100.

The microprocessor of locator module 340 at the next operation 404 determines if locator module 340 is being charged. If the microprocessor determines that locator module 340 is being charged, locator module 340 continues to remain active, transmitting its location information (or other data). If the microprocessor determines that locator module 340 is not being charged, locator module 340 sets a timer for motion at operation 406 and at operation 408 determines if the minimum timer threshold is met for motion (or lack thereof). Accordingly, locator module 340 will remain active for as long as motion is sensed within the set time where the time is reset otherwise, it reverts to sleep mode at operation 410 if no motion is sensed within the set minimum timer threshold.

Therefore, if at operation 408 it is determined that the minimum timer threshold is not met (no motion is sensed passed the threshold timer), at operation 410 locator module 340 becomes inactive (sleep mode) and continues to determine if motion is sensed at operation 412. In other words, when the EAS 100 is handled and physically changes orientation locator module 340 within the EAS tag 100 is activated, transmitting current location information to a central point. Accordingly, if EAS tag 100 and the associated article with which EAS tag 100 is coupled are stolen and moved to an unknown location, locator module 340 would transmit location information for potential recovery of the stolen merchandise, with the transmitted location information received and processed at a centrally authorized point.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An anti-theft tag, comprising:
a locator module for tracking location of the anti-theft tag;
the locator module providing location information with respect to the location of the anti-theft tag.

2. The anti-theft tag as set forth in claim 1, further comprising:
an Electronic Article Surveillance (EAS) module.

3. The anti-theft tag as set forth in claim 1, further comprising:
a coupler for associating the anti-theft tag with an article.

4. The anti-theft tag as set forth in claim 1, wherein:
the locator module is one of a Global Positioning System (GPS) or cellular triangulation device.

5. The anti-theft tag as set forth in claim 1, wherein:
the locator module is both a Global Positioning System (GPS) and cellular triangulation device.

6. The anti-theft tag as set forth in claim 2, further comprising:
a housing that accommodates:
the locator module;
the EAS module; and
a coupler.

7. The anti-theft tag as set forth in claim 1, wherein:
the locator module includes a rechargeable power source.

8. The anti-theft tag as set forth in claim 1, wherein:
the locator module includes an Input-Output (IO) port.

9. The anti-theft tag as set forth in claim 7, wherein:
the rechargeable power source is charged via a charging port coupled with an IO port.

10. The anti-theft tag as set forth in claim 9, wherein:
the charging port is one of a coaxial power connector and a Universal Serial Bus (USB).

11. The anti-theft tag as set forth in claim 9, wherein:
the charging port is a USB charging port that includes a micro-USB break-out board with power and ground coupled with the locator module to recharge the power source.

12. The anti-theft tag as set forth in claim 9, wherein:
the coaxial power connector is a barrel connector.

13. The anti-theft tag as set forth in claim 2, wherein:
the EAS module includes a one or more triggering units that sense and detect surveillance signals to generate a detected surveillance signal that trigger an alarm.

14. The anti-theft tag as set forth in claim 13, wherein:
the triggering units are transponders.

15. The anti-theft tag as set forth in claim 1, wherein:
the locator module is in an active mode when in motion, and reverts to sleep mode after a predetermined time of being motionless for saving power.

16. An anti-theft tag, comprising:
a locking cable that is coupled with a housing of an anti-theft tag;
the housing of the anti-theft tag includes:
a first member coupled with a second member, forming a hollow internal chamber within which is mounted a locator module for tracking location of the anti-theft tag, and a first side that includes a first aperture for accommodating an actuator switch;
the second member includes a protuberance that houses a clutch;
the first member and the second member include perforated areas that form the grill-openings of the housing for output of audio indicator.

17. The anti-theft tag as set forth in claim 16, wherein:
the first member further includes a triggering unit that senses and generates surveillance signals to trigger an alarm.

18. The anti-theft tag as set forth in claim 16, wherein:
the locking cable includes a first distal end that has a locking plug that interlocks with and is accommodated by the actuator switch.

19. The anti-theft tag as set forth in claim 16, wherein:
the cable lock includes a locking plug that is accommodated in a locking channel of the internal chamber of the first member of the housing, and inserted within a transversely oriented hollow portion of the actuator switch and locked when the locking plug is fully inserted and the actuator switch is moved to an active position.

20. The anti-theft alarm tag as set forth in claim 16, wherein:
the actuator switch is comprised of a second transversally oriented clutch aperture, perpendicular the first member to accommodate the clutch housed in the protuberance of the second member, which clutch locks in the actuator in the active position against a biasing mechanism;
the actuator switch further includes a flange that actuates a switch arm that contacts a second plunger switch of a second plunger, which switches power to the alarm system of the alarm tag.
